(19) United States
(12) Patent Application Publication
(10) Pub. No.: US 2026/0302450 A1
(43) Pub. Date: Oct. 1, 2026

(54) SECONDARY BATTERY AND METHOD OF MANUFACTURING THE SAME

(71) Applicant: SAMSUNG SDI CO., LTD., Yongin-si (KR)

(72) Inventor: YUNMI SHIN, Yongin-si (KR)

(21) Appl. No.: 19/556,438

(22) Filed: Mar. 4, 2026

(30) Foreign Application Priority Data
Mar. 31, 2025 (KR) 10-2025-0041661

(51) Int. Cl. H01M 50/171; H01M 10/0587; H01M 50/105; H01M 50/184

(52) U.S. Cl. CPC H01M 50/171; H01M 10/0587; H01M 50/105; H01M 50/184; H01M 2220/20

(57) ABSTRACT

A method of manufacturing a secondary battery is provided. The method includes a pouch preparation task of preparing a pouch including a body part providing an internal space and a cover part covering the body part, a sealing task of forming a side sealing part sealing the internal space by bonding the body part and an edge of the cover part with each other after an electrode assembly is equipped in the internal space, a Z folding task of bending the side sealing part with respect to two folding lines parallel to each other and folding the two folding lines in directions opposite to each other, an adhesive coating task of coating an adhesive on the folded side sealing part, and an adhesion fixing task of folding the side sealing part with the adhesive coated thereon to fix the side sealing part to a side surface of the body part.

### CROSS-REFERENCE TO RELATED APPLICATION

The present application claims priority to and the benefit of Korean Patent Application No. 10-2025-0041661, filed on Mar. 31, 2025, in the Ministry of Intellectual Property, the entire disclosure of which is incorporated herein by reference.

### BACKGROUND

### 1. Field

The present disclosure relates to a method of manufacturing a pouch-type secondary battery and a secondary battery configured to prevent damage due to pressing of an electrode plate and to prevent damage of a pouch caused by folding of a pouch sealing part.

### 2. Description of the Related Art

A primary battery incapable of being charged and a secondary battery capable of being charged and discharged are included in batteries. Low-capacity secondary batteries may be used in portable small-sized electric devices such as smartphones, feature phones, notebook computers, digital cameras, and camcorders, and large-capacity secondary batteries are being widely used as power-storing batteries and motor-driving power sources for hybrid vehicles, electric vehicles, etc.

In pouch-type secondary batteries, which are a type of secondary battery, an electrode assembly is accommodated in a pouch, an electrolyte is subsequently injected into the pouch, both side portions of the pouch are subsequently sealed, and a side sealing part is folded, thereby manufacturing the pouch-type secondary battery. The side sealing part is folded to secure a peripheral space of the secondary battery.

However, in a conventional side portion folding process, damage to an electrode plate may occur due to pressing a cell side surface, and the detachment of a sealing part may occur. When the sealing part is detached, an electrolyte may be leaked over time, and due to the leaking of the electrolyte, performance may be reduced, and a risk of fire or explosion may be caused. Also, when an electrode plate is damaged, an inner portion of a cell is short-circuited, or a resistance increases, thereby causing a reduction in battery lifetime and a reduction in safety.

Accordingly, it is beneficial to develop technology that may prevent (or at least mitigate) the damage of an electrode plate in a pouch when folding a side sealing part and that may maintain high sealing performance after folding.

The above information disclosed in this Background section is for enhancement of understanding of the background of the present disclosure, and therefore, it may contain information that does not constitute related (or prior) art.

### SUMMARY

An aspect of the present disclosure is directed to providing a secondary battery and a method of manufacturing the same, which may prevent (or at least mitigate) damage to an electrode plate in a pouch in a process of folding a side sealing part, and which may not cause the detachment of a sealing part to maintain structural safety, thereby enhancing production efficiency.

To achieve these and other advantages and in accordance with the purpose of the present disclosure, as embodied and broadly described herein, there is provided a method of manufacturing a secondary battery, the method including: a pouch preparation task including preparing a pouch including a body part providing an internal space and a cover part covering the body part; a sealing task including forming a side sealing part sealing the internal space by bonding the body part and an edge of the cover part with each other after an electrode assembly is inserted in the internal space; a Z folding task of bending the side sealing part with respect to two folding lines substantially parallel to each other and folding the two folding lines in directions opposite to each other; an adhesive coating task including coating an adhesive on the folded side sealing part; and an adhesion fixing task including folding the side sealing part with the adhesive coated thereon to fix the side sealing part to a side surface of the body part.

In another aspect of the present disclosure, there is provided a secondary battery including: a pouch including a body part providing an internal space and a cover part covering the body part; and an electrode assembly accommodated into the internal space and connected to an external circuit through first and second terminals, wherein a side sealing part formed by bonding the body part and an edge of the cover part with each other is included in the pouch, and the side sealing part is folded in zigzags and is fixed to the body part with being folded subsequently.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a perspective view of a stack-type electrode assembly capable of being equipped in a secondary battery according to embodiments of the present disclosure;

FIG. 2 is a perspective view of a winding-type electrode assembly applicable to a secondary battery according to embodiments of the present disclosure;

FIG. 3 is a diagram illustrating a shape where a pouch-type secondary battery is opened;

FIG. 4 is a perspective view of a secondary battery according to embodiments of the present disclosure;

FIG. 5 is an enlarged view of a region A of FIG. 4;

FIG. 6 is a diagram illustrating a shape before a side sealing part is bent, in a secondary battery according to embodiments of the present disclosure;

FIG. 7 is a flowchart for describing a method of manufacturing a secondary battery according to embodiments of the present disclosure;

FIGS. 8 to 12 are diagrams schematically illustrating a method of manufacturing a secondary battery according to embodiments of the present disclosure;

FIG. 13 is a flowchart illustrating another example of a method of manufacturing a secondary battery according to embodiments of the present disclosure;

FIGS. 14 to 16 are diagrams for describing a bending guide groove formation step (task) of FIG. 13;

FIG. 17 is a perspective view of a secondary battery pack where a secondary battery according to embodiments of the present disclosure is embedded; and

FIG. 18 is a diagram illustrating a shape where the secondary battery pack of FIG. 17 is equipped in a vehicle.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

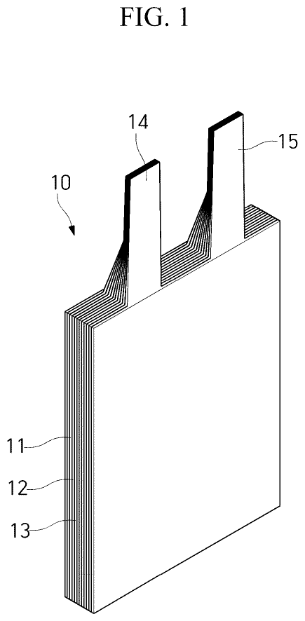

FIG. 1 is a perspective view of a stack-type electrode assembly configured to be provided in a secondary battery according to embodiments of the present disclosure.

As shown in FIG. 1, a secondary battery may include an electrode assembly, a first current collector, a first terminal, a second current collector, a second terminal, a case, and a cap assembly.

An electrode assembly may be formed by winding or stacking a stack of a first electrode plate, a separator, and a second electrode plate, which are formed as thin plates or films. When the electrode assembly is a wound stack, a winding axis may be parallel to the longitudinal direction (e.g., the y direction) of the case. In other embodiments, the electrode assembly may be a stack type rather than a winding type, and the shape of the electrode assembly is not limited in the present disclosure. In addition, the electrode assembly may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

The first electrode plate may be formed by applying a first electrode active material, such as graphite or carbon, to a first electrode current collector formed of a metal foil, such as copper, a copper alloy, nickel, or a nickel alloy. The first electrode plate may include a first electrode tab (e.g., a first uncoated portion) that is a region to which the first electrode active material is not applied. The first electrode tab may act as a current flow path between the first electrode plate and the first current collector. In some embodiments, when the first electrode plate is manufactured, the first electrode tab may be formed by being cut in advance to protrude to one side of the electrode assembly, or the first electrode tab may protrude to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab (e.g., a second uncoated portion) that is a region to which the second electrode active material is not applied. The second electrode tab may act as a current flow path between the second electrode plate and the second current collector. In some embodiments, the second electrode tab may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some embodiments, the first electrode tab may be located on the left side of the electrode assembly, and the second electrode tab may be located on the right side of the electrode assembly. In other embodiments, the first electrode tab and the second electrode tab may be located on one side of the electrode assembly in the same direction. Here, for convenience of description, the left and right sides are defined according to the secondary battery as oriented in FIG. 1, and the positions thereof may change when the secondary battery is rotated left and right or up and down.

The first electrode tab of the first electrode plate and the second electrode tab of the second electrode plate may be respectively positioned at both ends (e.g., opposite ends) of the electrode assembly. In some embodiments, the electrode assembly may be accommodated in the case along with an electrolyte. In addition, in the electrode assembly, the first current collector and the second current collector may be welded and connected to the first electrode tab of the first electrode plate and the second electrode tab of the second electrode plate exposed on both sides, respectively, to then be positioned thereat, respectively.

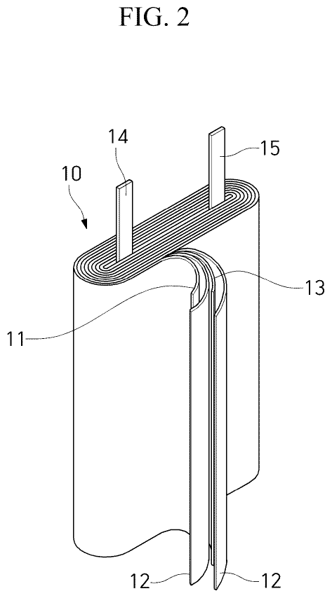

FIG. 2 is a perspective view of a winding-type electrode assembly 10 applicable to a secondary battery according to embodiments of the present disclosure.

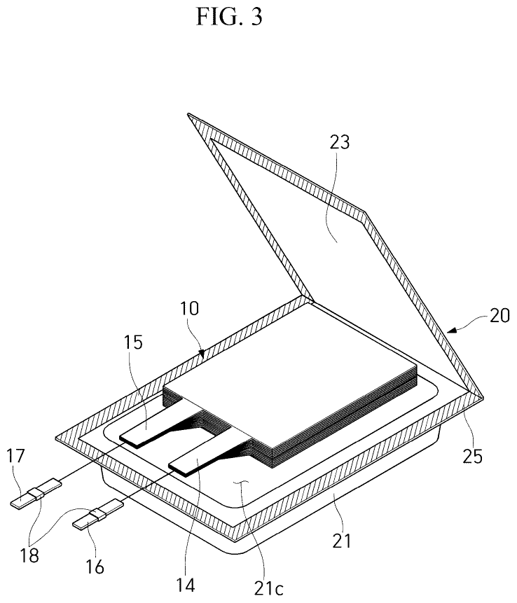

The electrode assembly 10 may be formed by winding a stack of a first electrode plate 11, a separator 12, and a second electrode plate 13, which are formed as a plate type or a film type. The first electrode plate 11, the separator 12, and the second electrode plate 13 may be wound in a stacked state to form one jelly roll. A structure and a function of each of the first electrode plate 11, the separator 12, and the second electrode plate 13 may be the same as the descriptions of FIG. 1. As illustrated in FIG. 3, the electrode assembly 10, may be accommodated into a pouch including a flexible material.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt% of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

FIG. 3 is a diagram illustrating a configuration in which a pouch-type secondary battery 30 is opened.

As illustrated in FIG. 3, an electrode assembly 10 may be accommodated into an internal space 21c of a pouch 20. In FIG. 3, the stack-type electrode assembly illustrated in FIG. 1 is illustrated, but the present disclosure is not limited thereto and, in one or more embodiments, the winding-type electrode assembly illustrated in FIG. 2 may be accommodated in the internal space 21c of the pouch 20.

The pouch 20 may be a vessel which is manufactured with a synthetic resin film having flexibility and may include a body part 21 and a cover part 23. The body part 21 may provide an internal space 21c which may accommodate the electrode assembly 10. The internal space 21c may be covered by the cover part 23.

Moreover, a first electrode tap 14 and a second electrode tap 15 of the electrode assembly 10 may be electrically connected to an external first terminal lid 16 and an external second terminal lid 17, respectively. A tap film 18 for insulation from an external pouch may be attached to the first terminal lid 16 and the second terminal lid 17. The first terminal lid 16 and the second terminal lid 17 may be connected to a circuit board or an electronic part of a battery application product (for example, electronic devices such as a portable phone, a tablet personal computer, and/or an electric fan).

A sealing part may be formed at an outer portion of the pouch 20. The sealing part may be a part which is formed by bonding the body part 21 and an edge of the cover part 23 with each other. In other words, a bonded part of the body part 21 and the cover part 23 may together be the sealing part. The sealing part may be a part which seals the internal space 21c of the body part 21.

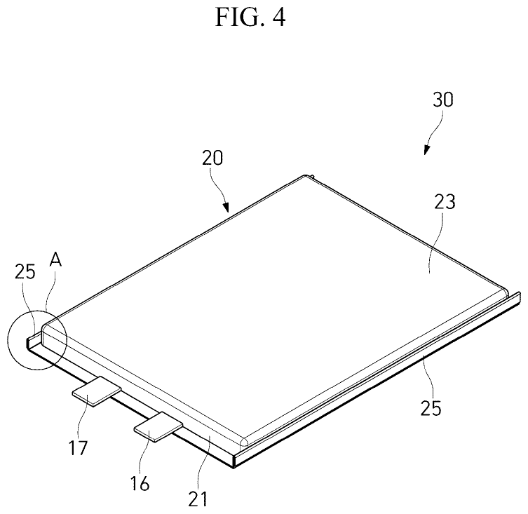

A side sealing part 25 may be included in the sealing part. The side sealing part 25 may be a part which is disposed on opposite sides with the body part 21 therebetween. As illustrated in FIG. 4, the side sealing part 25 may be adhered and fixed to a side portion of the body part 21 in a folded state. The folded state of the side sealing part 25 may be configured to secure a space in both side portions of the secondary battery.

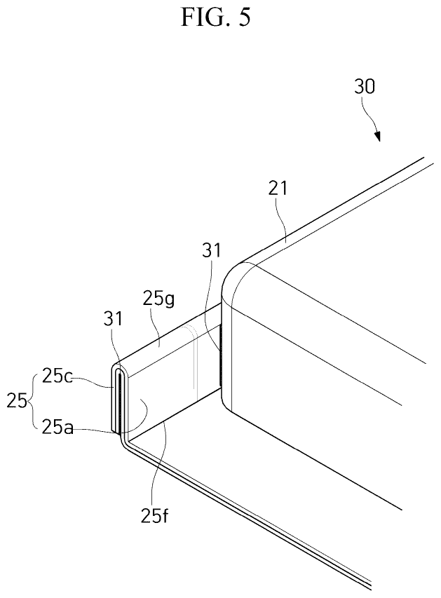

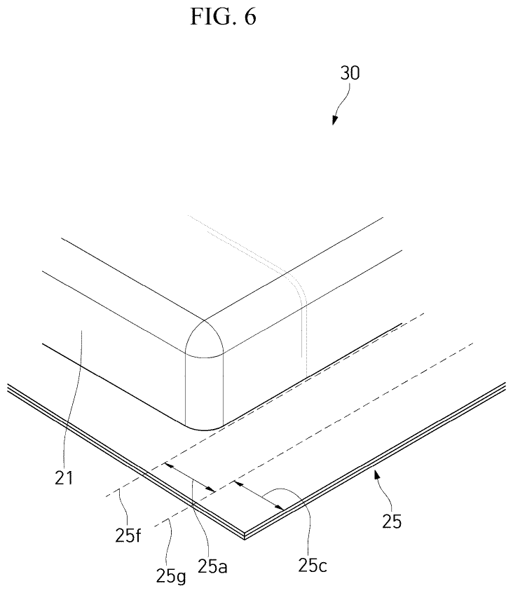

FIG. 4 is a perspective view of a secondary battery 30 according to embodiments of the present disclosure, and FIG. 5 is an enlarged view of a region A of the secondary battery 30 illustrated in FIG. 4. FIG. 6 is a diagram illustrating a configuration before a side sealing part 25 is bent and folded in a secondary battery according to embodiments of the present disclosure.

As illustrated, both side sealing parts 25 of the secondary battery 30 may be adhered to both surfaces of the body part 21 an both side sealing parts 25 may be folded. The side sealing part 25, as described below, may be bent in zigzags along a first folding line 25f and a second folding line 25g, may be subsequently folded, and may be subsequently adhered and fixed to a side surface of the body part 21.

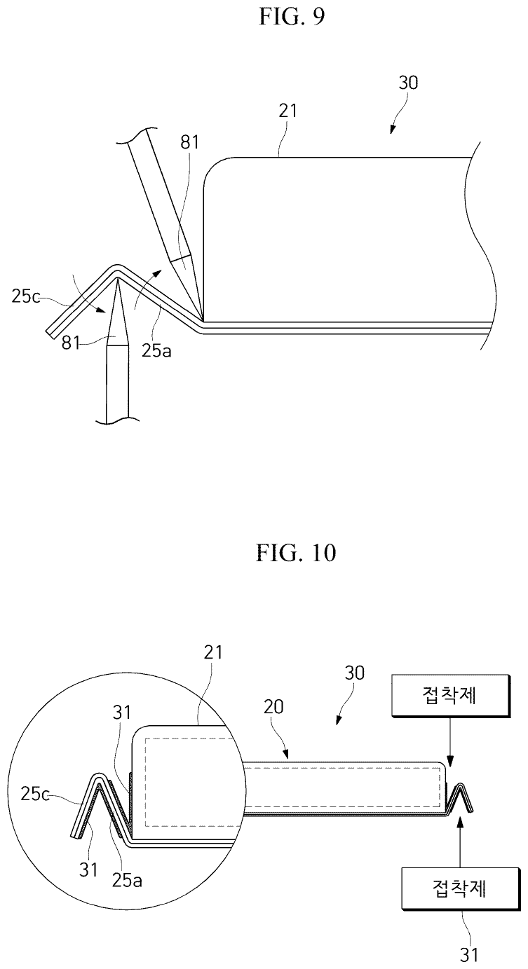

As illustrated in FIG. 6, a region of the side sealing part 25 may be divided with respect to the first folding line 25f and the second folding line 25g. Each of the first folding line 25f and the second folding line 25g may not be substantially marked (or otherwise visually indicated) in the side sealing part 25 and may be a virtual line illustrated in the drawing for convenience of description. In an embodiment in which the side sealing part 25 is folded, as illustrated in FIG. 9, the side sealing part 25 may be folded along the first folding line 25f and the second folding line 25g.

The first folding line 25f may be disposed at a boundary portion (or substantially at the boundary portion) where the body part 21 contacts the side sealing part 25. Also, the second folding line 25g may be parallel (or substantially parallel) to the first folding line 25f and may be disposed at a widthwise center portion (or a widthwise intermediate portion) of the side sealing part 25.

Moreover, a region between the first folding line 25f and the second folding line 25g may be an inner sealing part 25a. An outer portion with respect to the second folding line 25g may be an outer sealing part 25c. A width of each of the inner sealing part 25a and the second folding line 25g may be changed according to embodiments. For example, the inner sealing part 25a and the second folding line 25g may have the same width (or substantially the same width), or they may have different widths. In other words, a width of the inner sealing part 25a may be equal to (or substantially equal to), or wider than, or relatively narrower than that of the second folding line 25g.

The inner sealing part 25a may be adhered and fixed to the side surface of the body part 21. Also, the outer sealing part 25c may be adhered to and fixed to the inner sealing part 25a. In FIG. 5, a configuration is depicted in which the inner sealing part 25a and the outer sealing part 25c are folded and fixed to the side surface of the body part 21.

The inner sealing part 25a and the outer sealing part 25c may be fixed (coupled) to each other through an adhesive 31. Also, the inner sealing part 25a and the body part 21 may be fixed (coupled) to each other through the adhesive 31. As a result, the inner sealing part 25a and the outer sealing part 25c may be folded and may be bonded to each other and to the body part 21 with the adhesive 31.

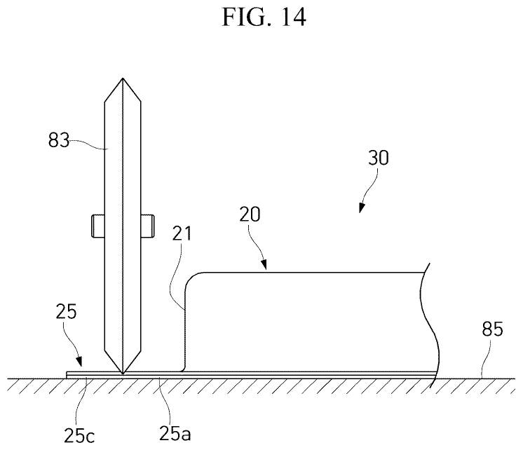

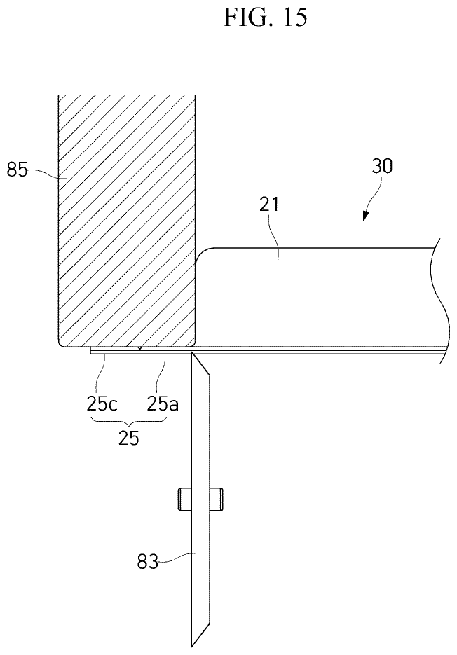

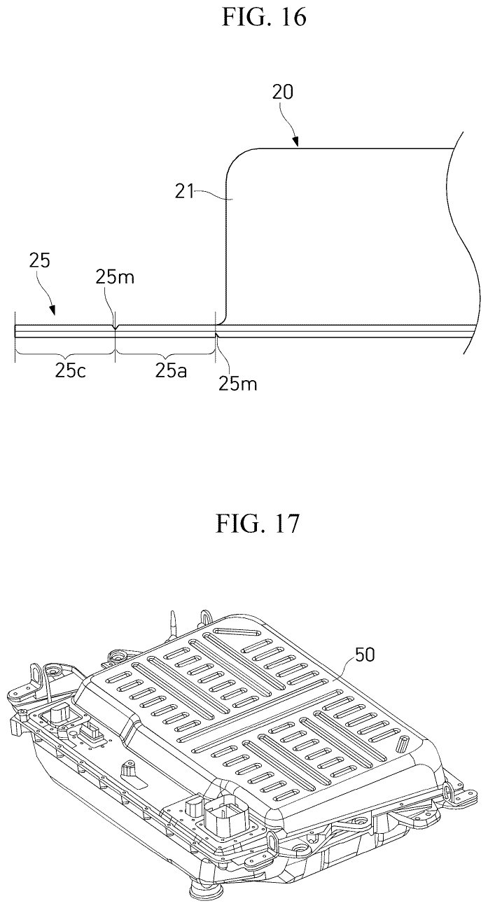

Moreover, as illustrated in FIG. 16, a bending guide grooves 25m may be further formed in each of an upper surface and a lower surface of the side sealing part 25 such that the inner sealing part 25a and the outer sealing part 25c may be smoothly (readily) folded. The bending guide groove 25m may be a notch groove having a V-shape and may be a rectilinear groove. The bending guide groove 25m may be formed by pressing the side sealing part 25 with a folding line former (83 in FIGS. 14 and 15).

In one or more embodiments, the secondary battery may include two bending guide grooves 25m. One of the bending guide grooves 25m may be formed between the inner sealing part 25a and the body part 21 and another one of the bending guide grooves 25m may be formed between the inner sealing part 25a and the outer sealing part 25c. The bending guide grooves 25m may be formed along the first folding line 25f and the second folding line 25g.

As described with reference to FIG. 16, one bending guide groove among two bending guide grooves 25m may be formed on one surface (an upper surface in the drawing of FIG. 16) of the side sealing part 25, and the other bending guide groove 25m among the two bending guide grooves 25m may be formed on the other surface (a lower surface of the side sealing part 25) of the side sealing part 25. However, according to another embodiment, each of the bending guide grooves 25m may be formed in both the upper surface and the lower surface of the side sealing part 25.

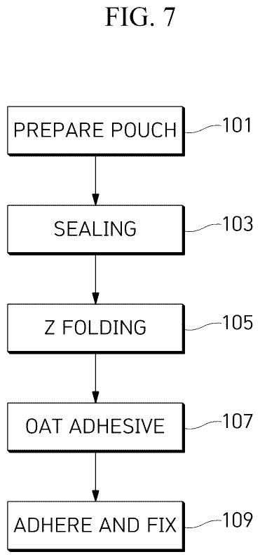

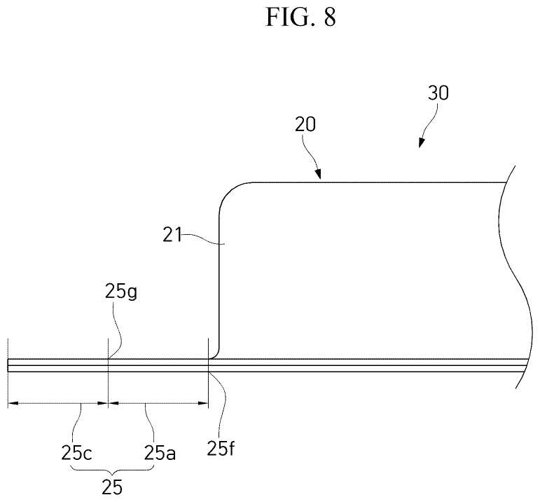

FIG. 7 is a flowchart for describing a method of manufacturing a secondary battery according to embodiments of the present disclosure, and FIGS. 8 to 12 are diagrams schematically illustrating a method of manufacturing a secondary battery according to embodiments of the present disclosure.

As illustrated in FIGS. 7 to 12, the method of manufacturing the secondary battery according to embodiments of the present disclosure may include a pouch preparation step (task) 101, a sealing step (task) 103, a Z folding step (task) 105, an adhesive coating step (task) 107, and an adhesion fixing step (task) 109.

The pouch preparation step (task) 101 may be a process of preparing the pouch 20 including the body part 21 and the cover part 23. As illustrated in FIG. 3, the internal space 21c may be formed (defined) in the body part 21. The electrode assembly 10 may be accommodated into the internal space 21c. Also, the cover part 23 may be a part which covers the body part 21 and the electrode assembly 10 accommodated in the internal space 21c of the body part 21. In a state in which the electrode assembly 10 is accommodated in the body part 21, the cover part 23 may cover the body part 21, and by bonding the body part 21 and the edge of the cover part 23 with each other, the internal space 21c (and the electrode assembly 10 accommodated therein) may be sealed.

Subsequently, the sealing step (task) 103 may be a process of bonding the body part 21 and the edge of the cover part 23 with each other to seal the internal space 21c and the electrode assembly 10 accommodated therein. A separate bonding device may be used for performing the sealing step (task) 103.

After the sealing step (task) 103 has concluded, the side sealing part 25 may be formed at each of both side portions of the secondary battery 30. The side sealing part 25 may be a part where double-layer pouch fabrics are bonded to each other. Also, as illustrated in FIG. 8, the inner sealing part 25a and the outer sealing part 25c may be included in the side sealing part 25. As described above, the inner sealing part 25a may denote a region between the first folding line 25f and the second folding line 25c, and the outer sealing part 25c may denote a region outside of the second folding line 25g.

After the sealing step (task) 103 is completed, the Z folding step (task) 105 may be performed. The Z folding step (task) 105 may be a process of bending the side sealing part 25 with respect to two folding lines (the first folding line 25f and the second folding line 25g) that are parallel (or substantially parallel) to each other, and for example, may be a process of folding the two folding lines 25f, 25g in directions opposite to each other. That is, the Z folding step (task) 105 may be a process of folding the both side sealing parts 25 into an approximate Z-shape.

In one or more embodiments, as illustrated in FIG. 9, the inner sealing part 25a may be bent upward, and the outer sealing part 25c may be bent downward. In other words, the sealing part 25 may be folded in a zigzag shape or configuration during the Z folding step (task) 105.

The bending guide grooves (25m of FIG. 16) may be formed such that the Z folding step (task) 105 is more smoothly (readily) performed. The bending guide grooves 25m may be rectilinear grooves which are formed along the first folding line 25f and the second folding line 25g. The bending guide grooves 25m may be formed by physically pressing the side sealing part 25 in a thickness direction (e.g., one of the bending guide grooves 25m may be formed by physically pressing an upper surface of the side sealing part 25 downward, and the other bending guide groove 25m may be formed by physically pressing a lower surface of the side sealing part 25 upward).

A bending blade 81 may be utilized for performing the Z folding step (task) 105. The bending blade 81 may be an instrument in which a linear blade part is formed at an end portion thereof. The blade part of the bending blade 81 may be adjusted between the inner sealing part 25a and the body part 21 and between the inner sealing part 25a and the outer sealing part 25c, and then, the inner sealing part 25a and the outer sealing part 25c may be bent in directions opposite to each other (e.g., upward and downward). Due to the Z folding step (task) 105, the inner sealing part 25a may be put into a state (configuration) in which the inner sealing part 25a may be adhered (e.g., directly adhered) to the body part 21, and the outer sealing part 25c may be put into a state (configuration) in which the outer sealing part 25c may be adhered (e.g., directly adhered) to the inner sealing part 25a.

Subsequently, the adhesive coating step (task) 107 may be performed. The adhesive coating step (task) 107 may be a process of coating the adhesive 31 on a folded sealing part. That is, as illustrated in FIG. 10, the adhesive coating step (task) 107 may be a process of applying the adhesive 31 between the inner sealing part 25a and the body part 21 (e.g., applying the adhesive 31 on an upper surface of the inner sealing part 25 and a side surface of the body part 21) and between the inner sealing part 25a and the outer sealing part 25c (e.g., applying the adhesive 31 on a lower surface of the inner sealing part 25a and a lower surface of the outer sealing part 25c).

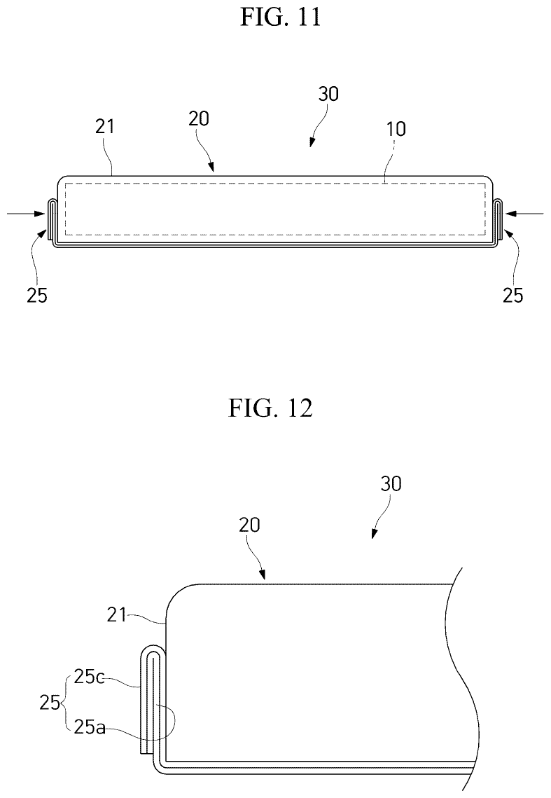

After coating of the adhesive 31 in the adhesive coating step (task) 107 has completed (concluded), the adhesion fixing step (task) 109 may be performed. The adhesion fixing step (task) 109 may be a process of folding the sealing part with the adhesive 31 coated thereon to fix (couple) the sealing part to the side surface of the body part 21. That is, as illustrated in FIG. 11, the adhesion fixing step (task) 109 may be a process of pressing the side sealing part 25 in a folded state (e.g., zigzag shape) toward the body part 21 to support the side sealing part 25.

After the adhesive coating step (task) 107 has completed (concluded), as illustrated in FIG. 12, the side sealing part 25 in the folded configuration may be adhered and fixed (coupled) to the body part 21.

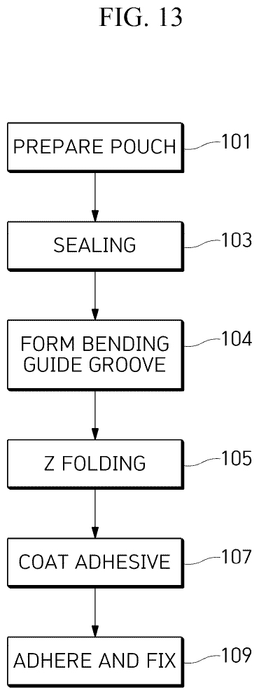

FIG. 13 is a flowchart illustrating another example of a method of manufacturing a secondary battery according to embodiments of the present disclosure, and FIGS. 14 to 16 are diagrams for describing a bending guide groove formation step (task) of FIG. 13. The same reference numerals as FIG. 7 refer to the same process, and thus, their repeated description is omitted below.

As illustrated in FIG. 13, the method of manufacturing the secondary battery according to embodiments of the present disclosure may include a pouch preparation step (task) 101, a sealing step (task) 103, a bending guide groove formation step (task) 104, a Z folding step (task) 105, an adhesive coating step (task) 107, and an adhesion fixing step (task) 109.

The bending guide groove formation step (task) 104 may be a process which is performed between the sealing step (task) 103 and the Z folding step (task) 105 and may be a process of forming the bending guide grooves 25m in the side sealing part 25. That is, the bending guide groove formation step (task) 104 may be a process of forming the bending guide groove 25m along each of the first folding line 25f and the second folding line 25g of the side sealing part 25.

The bending guide grooves 25m may both be a rectilinear groove which is formed by pressing the side sealing part 25 with the folding line former 83. Each of the bending guide grooves 25, as illustrated in FIG. 16, may have a shape of a V-shaped notch groove.

FIG. 14 illustrates a process in which the bending guide groove 25m is formed along the second folding line 25g (e.g., on the upper surface of the side sealing part 25). As illustrated, a folding line former 83 may be placed (positioned) on an upper surface of the side sealing part 25 along the second folding line 25g, and then the bending guide groove 25m may be formed with the folding line former 83. The folding line former 83 may be a disk-shaped member in which a blade is formed in an outer portion thereof, and like a wheel, a rolling motion may be performed.

A secondary battery 30 may be set in a prop jig 85, and then, in a state in which the folding line former 83 is placed (positioned) on the upper surface of the side sealing part 25 along the second folding line 25g, a straight movement is performed by applying pressure downward such that the bending guide groove 25 may be formed along the second folding line 25g in an upper surface of the side sealing part 25, as illustrated in FIG. 16.

Moreover, as illustrated in FIG. 15, when the secondary battery 30 is set in the prop jig 85 and the folding line former 83 is placed (positioned) on the lower surface of the side sealing part 25 along the first folding line 25f, the folding line former 83 may be moved upward by applying pressure upward under the side sealing part 25 such that the bending guide groove 25m may be formed in the lower surface of the side sealing part 25 along the first folding line 25f.

FIG. 16 illustrates a configuration in which the bending guide grooves 25m are formed in an upper surface and a lower surface of the side sealing part 25. One bending guide groove among the bending guide grooves 25m formed in the side sealing part 25 may be formed in one surface (i.e., the upper surface) of the side sealing part 25, and the other bending guide groove among the bending guide grooves 25m may be formed in the other surface (e.g., the lower surface). As described above, because the bending guide grooves 25m are formed in the side sealing part 25, bending of the side sealing part 25 along the first folding line 25f and the second folding line 25g may be more accurately and easily (readily) performed.

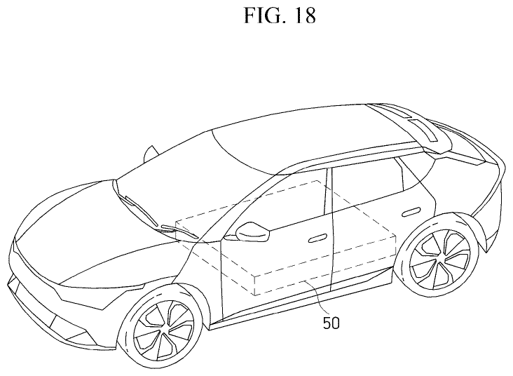

FIG. 17 is a perspective view of a secondary battery pack 50 in which a secondary battery according to embodiments of the present disclosure is embedded.

The battery, according to the above-described embodiments, may be used as part of a battery pack.

FIG. 17 is a view schematically showing the configuration of a secondary battery pack 50 according to an embodiment of the present disclosure.

Referring to FIG. 17, the secondary battery pack 50 according to an embodiment of the present disclosure includes an assembly to which individual batteries are electrically connected and a pack housing accommodating the same. In the drawings, for convenience of illustration, components including a bus bar, a cooling unit, external terminals for electrically connecting batteries, etc., are not shown.

The secondary battery pack 50 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto.

FIG. 18 is a diagram illustrating the secondary battery pack 50 of FIG. 17 equipped in a vehicle.

Referring to FIG. 18, the vehicle according to an embodiment of the present disclosure may include the secondary battery pack 50 according to an embodiment of the present disclosure. The vehicle may operate by (e.g., may be powered by) receiving power from the secondary battery pack 50.

As described above, the method of manufacturing the secondary battery according to embodiments of the present disclosure may prevent (or at least mitigate) damage to an electrode plate in a pouch in a process of folding a side sealing part and may not cause detachment of a sealing part to maintain structural safety of the secondary battery, thereby enhancing production efficiency.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of manufacturing a secondary battery, the method comprising:
a pouch preparation task comprising preparing a pouch comprising a body part providing an internal space and a cover part covering the body part;
a sealing task forming a side sealing part sealing the internal space, the sealing task comprising bonding the body part and an edge of the cover part to each other after an electrode assembly is inserted into the internal space;
a Z folding task comprising bending the side sealing part with respect to two folding lines substantially parallel to each other and folding the two folding lines in directions opposite to each other;
an adhesive coating task comprising coating an adhesive on the side sealing part after the Z folding task; and
an adhesion fixing task comprising folding the side sealing part with the adhesive coated thereon to fix the side sealing part to a side surface of the body part.

2. The method of claim 1, wherein the two folding lines comprise a first folding line at a boundary between the side sealing part and the body part and a second folding line between the first folding line and an end portion of the side sealing part,
wherein the side sealing part comprises an inner sealing part and an outer sealing part, the inner sealing part being a region between the first folding line and the second folding line and the outer sealing part being a a region outside the second folding line, and
wherein the Z folding task comprises a process of folding the side sealing part such that the inner sealing part contacts the body part, and the outer sealing part is adhered to the outer sealing part.

3. The method of claim 2, wherein the adhesive coating task comprises a process of applying the adhesive between the inner sealing part and the body part and between the inner sealing part and the outer sealing part.

4. The method of claim 2, wherein the inner sealing part and the outer sealing part have substantially a same width or different widths.

5. The method of claim 2, further comprising pressing the side sealing part along each of the two folding lines, the pressing forming a rectilinear bending guide groove.

6. The method of claim 1, further comprising a bending guide groove formation task comprising forming the bending guide groove in the side sealing part along each of the two folding lines,
wherein the bending guide groove formation task is performed between the sealing task and the Z folding task.

7. The method of claim 6, wherein the bending guide groove is a rectilinear groove formed by pressing the side sealing part with a folding line former.

8. The method of claim 7, further comprising a task of propping and supporting the side sealing part at a side opposite to the folding line former during the pressing of the side sealing part with the folding line former.

9. The method of claim 7, wherein one bending guide groove among a plurality of bending guide grooves is formed on one surface of the side sealing part, and wherein another bending guide groove among the plurality of bending guide grooves is formed on another surface of the side sealing part.

10. The method of claim 7, wherein the bending guide groove has a shape of a V-shaped notch groove.

11. A secondary battery comprising:
a pouch comprising a body part providing an internal space and a cover part covering the body part; and
an electrode assembly accommodated in the internal space and connected to an external circuit through first and second terminals,
wherein a side sealing part formed by bonding the body part and an edge of the cover part with each other is included in the pouch, and the side sealing part is folded in zigzags and is fixed to the body part with being folded subsequently.

12. The secondary battery of claim 11, wherein the side sealing part comprises an inner sealing part adhered to the body part and an outer sealing part adhered to the inner sealing part.

13. The secondary battery of claim 12, further comprising a rectilinear bending guide groove between the inner sealing part and the body part and between the inner sealing part and the outer sealing part.

14. The secondary battery of claim 13, wherein one bending guide groove among a plurality of bending guide grooves is on one surface of the side sealing part, and wherein another bending guide groove among the plurality of bending guide grooves is on another surface of the side sealing part.

15. The secondary battery of claim 12, wherein the inner sealing part and the outer sealing part have substantially a same width.

16. The secondary battery of claim 12, wherein the inner sealing part and the outer sealing part have different widths.

17. The secondary battery of claim 12, wherein the inner sealing part and the outer sealing part are fixed to each other by an adhesive.

18. The secondary battery of claim 12, wherein the inner sealing part and the body part are fixed to each other by an adhesive.

19. The secondary battery of claim 13, wherein the bending guide groove has a shape of a V-shaped notch groove.

20. The secondary battery of claim 13, wherein the bending guide groove is a rectilinear groove formed by pressing the side sealing part with a folding line former.
